(19) United States
(12) Patent Application Publication
(10) Pub. No.: US 2015/0118980 A1
(43) Pub. Date: Apr. 30, 2015

(54) TRANSMITTER (TX) RESIDUAL SIDEBAND (RSB) AND LOCAL OSCILLATOR (LO) LEAKAGE CALIBRATION USING A RECONFIGURABLE TONE GENERATOR (TG) AND LO PATHS

(71) Applicant: QUALCOMM Incorporated, San Diego, CA (US)

(72) Inventors: Lai Kan LEUNG, San Marcos, CA (US); Chiewcharn NARATHONG, Laguna Niguel, CA (US); Jianyun HU, San Diego, CA (US)

(73) Assignee: QUALCOMM INCORPORATED, San Diego, CA (US)

(21) Appl. No.: 14/264,951

(22) Filed: Apr. 29, 2014

Related U.S. Application Data
(60) Provisional application No. 61/896,967, filed on Oct. 29, 2013.

(51) Int. Cl. H04B 1/04; H04B 1/38

(52) U.S. Cl. CPC H04B 1/0475; H04B 1/38; H04B 2001/045
USPC 455/114.2

(57) ABSTRACT

Certain aspects of the present disclosure provide methods and apparatus for calibrating a transceiver for wireless communications. One example method generally includes configuring a first oscillating signal as an input signal to at least a portion of a receiver (RX) path, calibrating a residual sideband (RSB) of the receiver path using a second oscillating signal as a local oscillating signal for the receiver path, and calibrating an RSB of a transmitter (TX) path by routing an output of the transmitter path to the receiver path, after calibrating the RSB of the receiver path. Another example method generally includes routing an output of a transmitter path to a receiver path, using a first local oscillating signal for the transmitter path, using a second local oscillating signal for the receiver path, and measuring an output of the receiver path as a local oscillator (LO) leakage for the transmitter path.

### CLAIM OF PRIORITY UNDER 35 U.S.C. §119

This application claims benefit of U.S. Provisional Patent Application Ser. No. 61/896,967, filed Oct. 29, 2013 and entitled “Transmitter (Tx) Residual Sideband (RSB) and Local Oscillator (LO) Leakage Calibration Using the Reconfigurable Single Tone Generator (STG) and LO Paths,” which is herein incorporated by reference in its entirety.

### TECHNICAL FIELD

Certain aspects of the present disclosure generally relate to radio frequency (RF) circuits and, more particularly, to calibrating a residual sideband (RSB) of a transmitter path in a transceiver and to calibrating a local oscillator (LO) leakage of the transmitter path.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. For example, one network may be a 3G (the third generation of mobile phone standards and technology) system, which may provide network service via any one of various 3G radio access technologies (RATs) including EVDO (Evolution-Data Optimized), 1xRTT (1 times Radio Transmission Technology, or simply 1x), W-CDMA (Wideband Code Division Multiple Access), UMTS-TDD (Universal Mobile Telecommunications System-Time Division Duplexing), HSPA (High Speed Packet Access), GPRS (General Packet Radio Service), or EDGE (Enhanced Data rates for Global Evolution). The 3G network is a wide area cellular telephone network that evolved to incorporate high-speed internet access and video telephony, in addition to voice calls. Furthermore, a 3G network may be more established and provide larger coverage areas than other network systems. Such multiple access networks may also include code division multiple access (CDMA) systems, time division multiple access (TDMA) systems, frequency division multiple access (FDMA) systems, orthogonal frequency division multiple access (OFDMA) systems, single-carrier FDMA (SC-FDMA) networks, 3^{rd} Generation Partnership Project (3GPP) Long Term Evolution (LTE) networks, Long Term Evolution Advanced (LTE-A) networks, and other 4G networks.

A wireless communication network may include a number of base stations that can support communication for a number of mobile stations. A mobile station (MS) may communicate with a base station (BS) via a downlink and an uplink. The downlink (or forward link) refers to the communication link from the base station to the mobile station, and the uplink (or reverse link) refers to the communication link from the mobile station to the base station. A base station may transmit data and control information on the downlink to a mobile station and/or may receive data and control information on the uplink from the mobile station.

### SUMMARY

Certain aspects of the present disclosure generally relate to transmitter modules. More specifically, certain aspects of the present disclosure generally relate to reconfiguring a tone generator (TG) and the transmitter (TX) synthesizer/LO (local oscillator) paths to calibrate the TX residual sideband (RSB)/image suppression and/or the TX LO leakage/carrier suppression.

Certain aspects of the present disclosure provide a method for calibrating a transceiver for wireless communications. The method generally includes configuring a first oscillating signal as an input signal to at least a portion of a receiver (RX) path, calibrating a residual sideband (RSB) of the receiver path using a second oscillating signal as a local oscillating signal for the receiver path, and calibrating an RSB of the transmitter path by routing an output of the transmitter path to the receiver path, after calibrating the RSB of the receiver path. For certain aspects, the receiver path may be a feedback receiver (FBRX) path internal to the transceiver.

Certain aspects of the present disclosure provide an apparatus for wireless communications. The apparatus generally includes a transmitter path, a receiver path, and a processing system. The processing system is typically configured to configure a first oscillating signal as an input signal to at least a portion of the receiver path, to calibrate an RSB of the receiver path using a second oscillating signal as a local oscillating signal for the receiver path, and to calibrate an RSB of the transmitter path by routing an output of the transmitter path to the receiver path, after calibrating the RSB of the receiver path.

Certain aspects of the present disclosure provide an apparatus for calibrating a transceiver for wireless communications. The apparatus generally includes means for configuring a first oscillating signal as an input signal to at least a portion of a receiver path, means for calibrating an RSB of the receiver path using a second oscillating signal as a local oscillating signal for the receiver path, and means for calibrating an RSB of the transmitter path by routing an output of the transmitter path to the receiver path, after calibrating the RSB of the receiver path.

Certain aspects of the present disclosure provide a method for calibrating a transceiver for wireless communications. The method generally includes routing an output of a transmitter path to a receiver path; using a first local oscillating signal for the transmitter path; using a second local oscillating signal for the receiver path, wherein the first local oscillating signal has a first frequency different from a second frequency of the second local oscillating signal; and measuring an output of the receiver path as a local oscillator (LO) leakage for the transmitter path.

Certain aspects of the present disclosure provide an apparatus for wireless communications. The apparatus generally includes a transmitter path; a receiver path; and a processing system. The processing system is typically configured to route an output of the transmitter path to the receiver path; to use a first local oscillating signal for the transmitter path; to use a second local oscillating signal for the receiver path, wherein the first local oscillating signal has a first frequency different from a second frequency of the second local oscillating signal; and to measure an output of the receiver path as a LO leakage for the transmitter path.

Certain aspects of the present disclosure provide an apparatus for calibrating a transceiver for wireless communications. The apparatus generally includes means for routing an output of a transmitter path to a receiver path; means for using a first local oscillating signal for the transmitter path; means for using a second local oscillating signal for the receiver path, wherein the first local oscillating signal has a first frequency different from a second frequency of the second local oscillating signal; and means for measuring an output of the receiver path as a LO leakage for the transmitter path.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network in accordance with certain aspects of the present disclosure.

FIG. 2 is a block diagram of an example access point (AP) and example user terminals in accordance with certain aspects of the present disclosure.

FIG. 3A is an example block diagram of a transceiver circuit configured to calibrate a residual sideband (RSB) of a feedback receiver (FBRX) as a first step to calibrating the RSB of the transmitter (TX) path, in accordance with certain aspects of the present disclosure.

FIG. 3B is an example block diagram of the transceiver circuit of FIG. 3A configured to calibrate the TX RSB after calibrating the FBRX RSB, in accordance with certain aspects of the present disclosure.

FIG. 3C is an example block diagram of the transceiver circuit of FIG. 3A configured to calibrate the RSB of the FBRX as an alternative to the configuration in FIG. 3A, in accordance with certain aspects of the present disclosure.

FIG. 3D is an example block diagram of the transceiver circuit of FIG. 3A configured to calibrate the TX RSB after calibrating the FBRX RSB according to the configuration in FIG. 3C, in accordance with certain aspects of the present disclosure.

FIG. 4 is an example block diagram of the transceiver circuit of FIG. 3A configured to calibrate the TX local oscillator (LO) leakage, in accordance with certain aspects of the present disclosure.

FIG. 5A is an example block diagram of a tone generator (TG) used in FIGS. 3A and 4, in accordance with certain aspects of the present disclosure.

FIG. 5B is an example block diagram of a multi-stage voltage-controlled oscillator (VCO) for the TG of FIG. 5A, in accordance with certain aspects of the present disclosure.

FIG. 6 is a flow diagram of example operations for calibrating the RSB of a transmitter path, in accordance with certain aspects of the present disclosure.

FIG. 7 is a flow diagram of example operations for calibrating the LO leakage of a transmitter path, in accordance with certain aspects of the present disclosure.

### DETAILED DESCRIPTION

Various aspects of the present disclosure are described below. It should be apparent that the teachings herein may be embodied in a wide variety of forms and that any specific structure, function, or both being disclosed herein is merely representative. Based on the teachings herein, one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

The word “exemplary” is used herein to mean “serving as an example, instance, or illustration.” Any aspect described herein as “exemplary” is not necessarily to be construed as preferred or advantageous over other aspects.

The techniques described herein may be used in combination with various wireless technologies such as Code Division Multiple Access (CDMA), Orthogonal Frequency Division Multiplexing (OFDM), Time Division Multiple Access (TDMA), Spatial Division Multiple Access (SDMA), Single Carrier Frequency Division Multiple Access (SC-FDMA), Time Division Synchronous Code Division Multiple Access (TD-SCDMA), and so on. Multiple user terminals can concurrently transmit/receive data via different (1) orthogonal code channels for CDMA, (2) time slots for TDMA, or (3) sub-bands for OFDM. A CDMA system may implement IS-2000, IS-95, IS-856, Wideband-CDMA (W-CDMA), or some other standards. An OFDM system may implement Institute of Electrical and Electronics Engineers (IEEE) 802.11, IEEE 802.16, Long Term Evolution (LTE) (e.g., in TDD and/or FDD modes), or some other standards. A TDMA system may implement Global System for Mobile Communications (GSM) or some other standards. These various standards are known in the art.

### An Example Wireless System

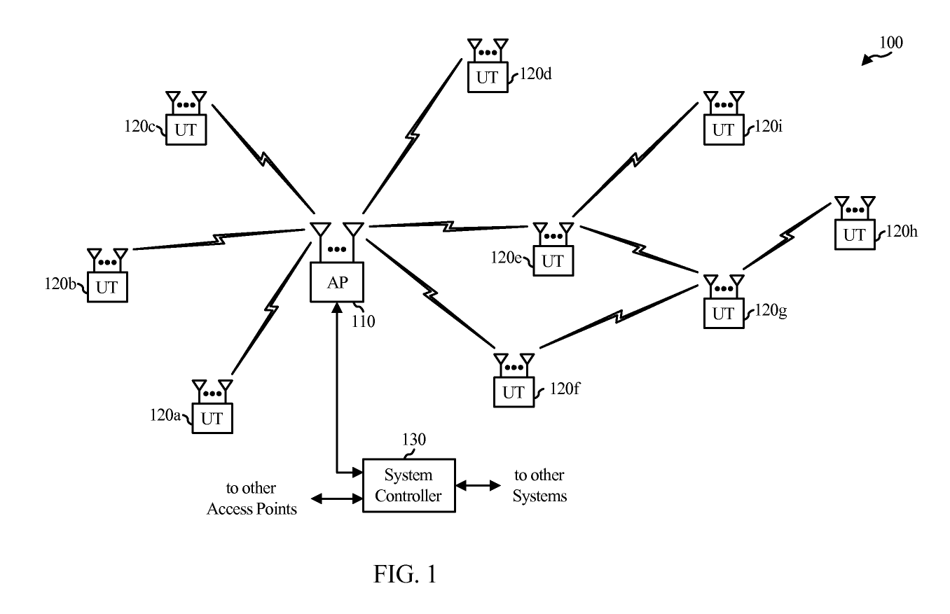

FIG. 1 illustrates a wireless communications system 100 with access points and user terminals. For simplicity, only one access point 110 is shown in FIG. 1. An access point (AP) is generally a fixed station that communicates with the user terminals and may also be referred to as a base station (BS), an evolved Node B (eNB), or some other terminology. A user terminal (UT) may be fixed or mobile and may also be referred to as a mobile station (MS), an access terminal, user equipment (UE), a station (STA), a client, a wireless device, or some other terminology. A user terminal may be a wireless device, such as a cellular phone, a personal digital assistant (PDA), a handheld device, a wireless modem, a laptop computer, a tablet, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

System 100 employs multiple transmit and multiple receive antennas for data transmission on the downlink and uplink. Access point 110 may be equipped with a number Nₐₚ of antennas to achieve transmit diversity for downlink transmissions and/or receive diversity for uplink transmissions. A set Nᵤ of selected user terminals 120 may receive downlink transmissions and transmit uplink transmissions. Each selected user terminal transmits user-specific data to and/or receives user-specific data from the access point. In general, each selected user terminal may be equipped with one or multiple antennas (i.e., Nᵤₜ≧1). The Nᵤ selected user terminals can have the same or different number of antennas.

Wireless system 100 may be a time division duplex (TDD) system or a frequency division duplex (FDD) system. For a TDD system, the downlink and uplink share the same frequency band. For an FDD system, the downlink and uplink use different frequency bands. System 100 may also utilize a single carrier or multiple carriers for transmission. Each user terminal may be equipped with a single antenna (e.g., in order to keep costs down) or multiple antennas (e.g., where the additional cost can be supported).

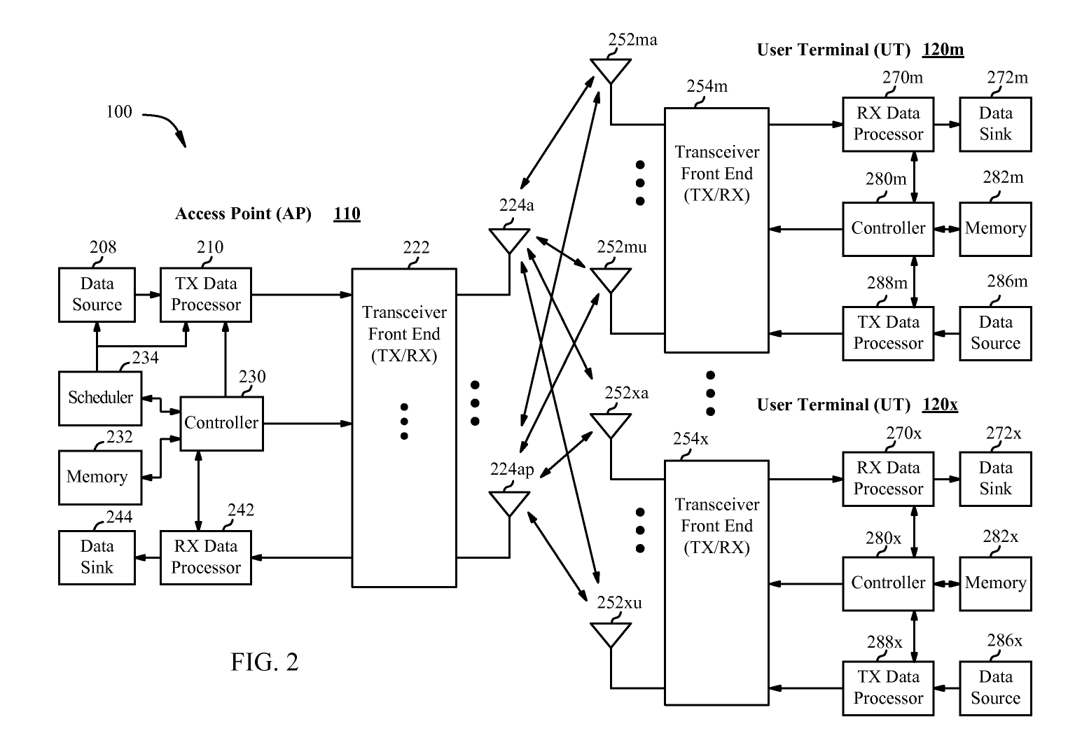

FIG. 2 shows a block diagram of access point 110 and two user terminals 120m and 120x in wireless system 100. Access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. Beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data {dᵤₚ} for the user terminal based on the coding and modulation schemes associated with the rate selected for the user terminal and provides a data symbol stream {sᵤₚ} for one of the N_{ut,m} antennas. A transceiver front end (TX/RX) 254 (also known as a radio frequency front end (RFFE)) receives and processes (e.g., converts to analog, amplifies, filters, and frequency upconverts) a respective symbol stream to generate an uplink signal. The transceiver front end 254 may also route the uplink signal to one of the N_{ut,m} antennas for transmit diversity via an RF switch, for example. The controller 280 may control the routing within the transceiver front end 254. Memory 282 may store data and program codes for the user terminal 120 and may interface with the controller 280.

A number Nᵤₚ of user terminals may be scheduled for simultaneous transmission on the uplink. Each of these user terminals transmits its set of processed symbol streams on the uplink to the access point.

At access point 110, Nₐₚ antennas 224a through 224ap receive the uplink signals from all Nᵤₚ user terminals transmitting on the uplink. For receive diversity, a transceiver front end 222 may select signals received from one of the antennas 224 for processing. For certain aspects of the present disclosure, a combination of the signals received from multiple antennas 224 may be combined for enhanced receive diversity. The access point's transceiver front end 222 also performs processing complementary to that performed by the user terminal's transceiver front end 254 and provides a recovered uplink data symbol stream. The recovered uplink data symbol stream is an estimate of a data symbol stream {sᵤₚ} transmitted by a user terminal. An RX data processor 242 processes (e.g., demodulates, deinterleaves, and decodes) the recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230 and possibly other data from a scheduler 234. The various types of data may be sent on different transport channels. TX data processor 210 processes (e.g., encodes, interleaves, and modulates) the traffic data for each user terminal based on the rate selected for that user terminal TX data processor 210 may provide a downlink data symbol streams for one of more of the N_{dn} user terminals to be transmitted from one of the Nₐₚ antennas. The transceiver front end 222 receives and processes (e.g., converts to analog, amplifies, filters, and frequency upconverts) the symbol stream to generate a downlink signal. The transceiver front end 222 may also route the downlink signal to one or more of the Nₐₚ antennas 224 for transmit diversity via an RF switch, for example. The controller 230 may control the routing within the transceiver front end 222. Memory 232 may store data and program codes for the access point 110 and may interface with the controller 230

At each user terminal 120, N_{ut,m} antennas 252 receive the downlink signals from access point 110. For receive diversity at the user terminal 120, the transceiver front end 254 may select signals received from one of the antennas 252 for processing. For certain aspects of the present disclosure, a combination of the signals received from multiple antennas 252 may be combined for enhanced receive diversity. The user terminal's transceiver front end 254 also performs processing complementary to that performed by the access point's transceiver front end 222 and provides a recovered downlink data symbol stream. An RX data processor 270 processes (e.g., demodulates, deinterleaves, and decodes) the recovered downlink data symbol stream to obtain decoded data for the user terminal.

Those skilled in the art will recognize the techniques described herein may be generally applied in systems utilizing any type of multiple access schemes, such as TDMA, SDMA, Orthogonal Frequency Division Multiple Access (OFDMA), CDMA, SC-FDMA, TD-SCDMA, and combinations thereof.

### Example TX RSB and LO Leakage Calibration

A local oscillator (LO) is typically included in radio frequency front-ends (RFFEs), such as transceiver front end 222 or 254, to generate a signal utilized to convert a signal of interest to a different frequency using a mixer. Known as heterodyning, this frequency conversion process produces the sum and difference frequencies of the LO frequency and the frequency of the signal of interest. The sum and difference frequencies are referred to as the beat frequencies. While it is desirable for the output of a LO to remain stable in frequency, tuning to different frequencies indicates using a variable-frequency oscillator, which involves compromises between stability and tunability. Contemporary systems employ frequency synthesizers with a voltage-controlled oscillator (VCO) to generate a stable, tunable LO with a particular tuning range.

In order to increase the power efficiency, envelope tracking (ET) or envelope power tracking (EPT) is used in a transmitter (TX). In an ET/EPT system, the specification of the residual sideband (RSB) and local oscillator (LO) leakage in the transmitter is more stringent (at least by 5 dB and 3 dB respectively, compared to a non-ET/EPT system) and usually cannot be complied with over process corners in order to meet the desired adjacent channel leakage ratio (ACLR).

In order to guarantee compliance over process corner variations, the TX RSB and/or LO leakage may most likely be calibrated. However, calibration of these radio frequency (RF) parameters at high frequency is technically challenging.

One solution is to collect enormous amounts of data over the various process corners at the TX driver amplifier (DA) or power amplifier (PA) outputs at RF frequency. For each band and process corner, the phase and gain mismatches (for RSB compensation) and DC offsets (for LO leakage compensation) may be derived statistically. Compensation based on the statistically derived phase and gain mismatches may then be applied (e.g., at the digital-to-analog converter (DAC) inputs) to all transceiver integrated circuits (ICs). The compensated performance depends on the accuracy of the statistically derived phase and gain mismatches (and, thus, on the amount of data collected), and the overall improvement is not as good as part-to-part calibration. Furthermore, the compensation is only a partial compensation of the TX path if the TX DAC is not located on the same IC as the remainder of the TX signal path.

Another solution for the TX LO leakage calibration is to use the same TX LO for both the TX signal path and the feedback receiver (FBRX) path. The RF tone at the power amplifier (PA) output in the TX path may then be coupled to the FBRX and down-converted as a DC tone at the FBRX output. The DC tone may be used to adjust the DC offsets before the TX DAC inputs to decrease the TX LO leakage. However, due to the contamination caused by the DC offset of the FBRX, the improvement in the TX LO leakage after the calibration is limited.

Accordingly, what is needed are techniques and apparatus for more accurately calibrating the TX RSB and/or LO leakage.

According to certain aspects of the present disclosure, both the TX RSB and LO leakage are calibrated on a part-to-part basis, as part of the “internal device calibration” on the user terminal 120. This is possible since the calibration can be autonomous and no external signal is needed from the callbox or other external equipment (i.e., self-calibration).

### Example TX RSB Calibration

RSB calibration, correction, or adjustment may also be referred to as quadrature mismatch calibration, sideband suppression, or image suppression. For ease of description and to avoid confusion, the present disclosure hereinafter uses RSB calibration.

In order to calibrate the TX RSB, the RSB of a receiver path (e.g., the FBRX RSB) may be compensated first, and then the TX RSB may be compensated using the calibrated receiver path. Although, any receiver path may be used, for ease of explanation the description that follows uses the FBRX since outputs from the transmitter path are intended to be routed to the FBRX for internal measurements.

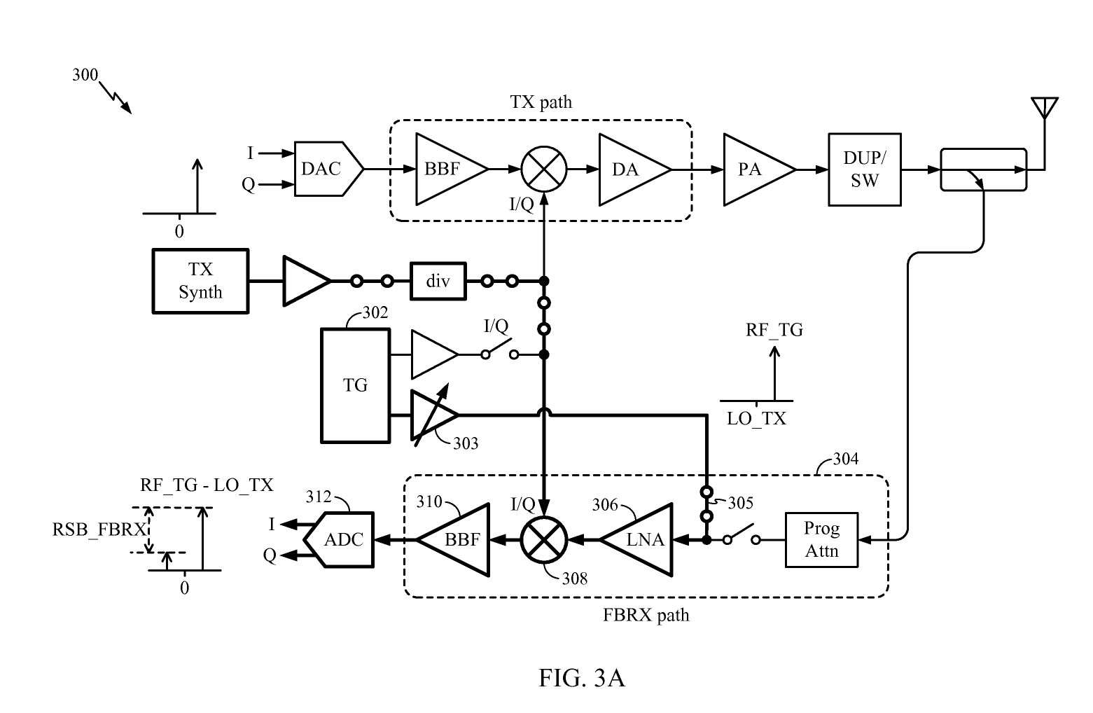

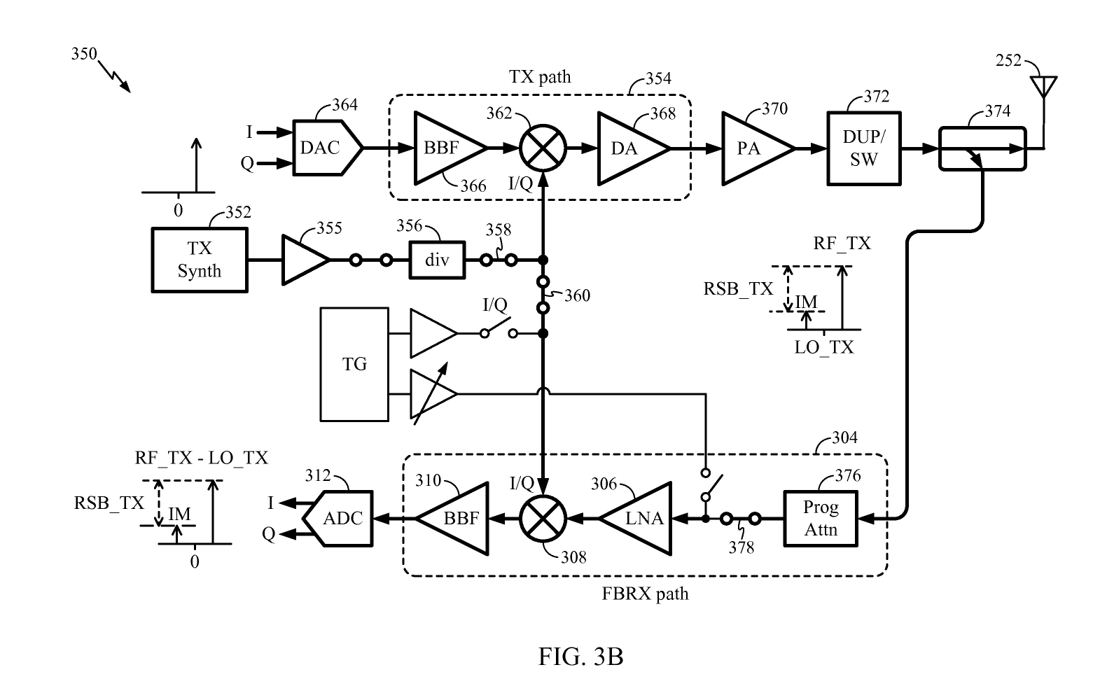

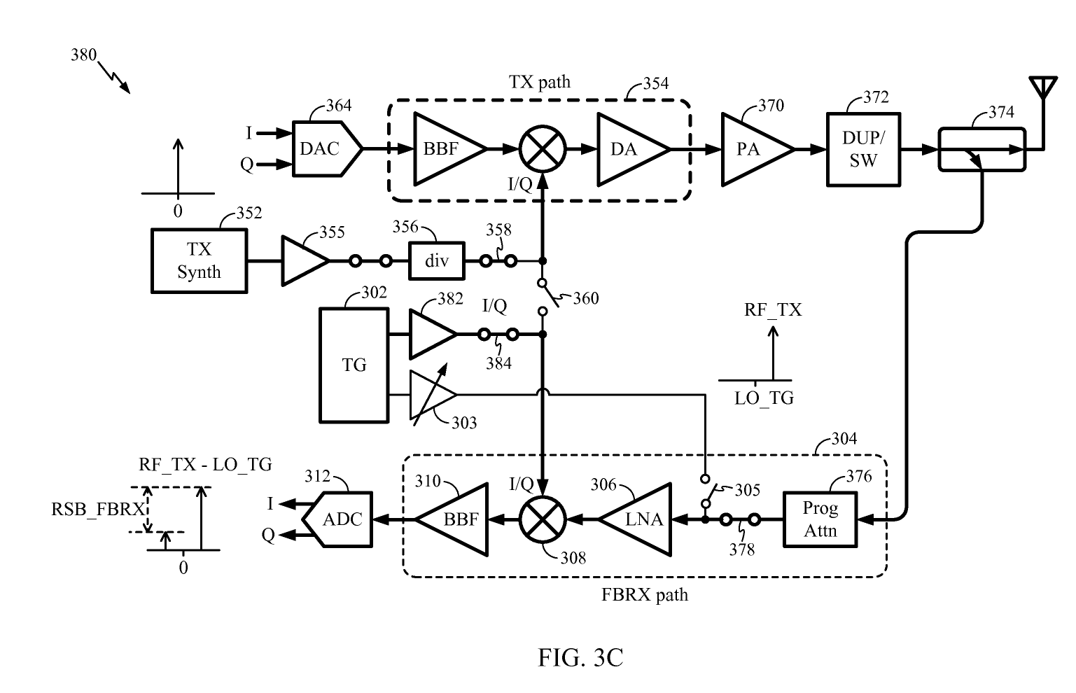

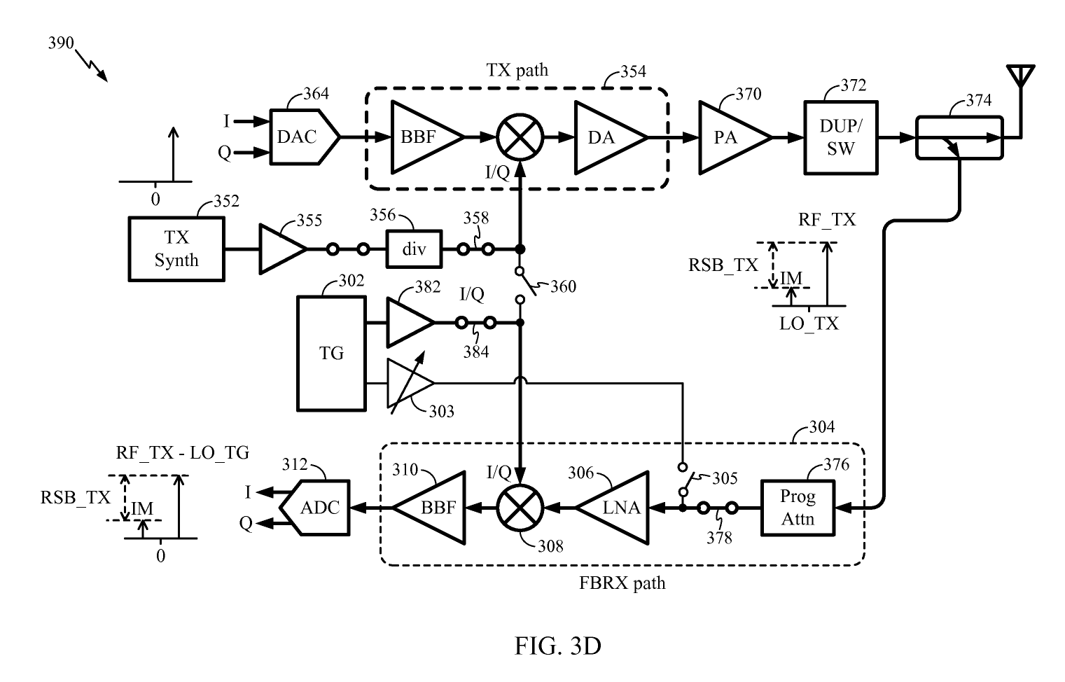

FIG. 3A is an example block diagram of a transceiver circuit in a first configuration 300 for calibrating the FBRX RSB, in accordance with certain aspects of the present disclosure. The bolded circuit components illustrate the portions of the transceiver circuit being used for each step in the TX RSB calibration. Since it is difficult to produce a pure tone having only a single frequency without any harmonics, a “tone” as used herein generally refers to a signal characterized by a single specific fundamental frequency, where harmonics are at least 20 dB down from the amplitude of the fundamental frequency.

In the first configuration 300, the output of a tone generator (TG) 302 used to produce a continuous wave (CW) signal (e.g., a single tone generator (STG) outputting a single frequency) is configured as the RF input to the FBRX path 304 via a switch 305 (shown in the closed position). For certain aspects as illustrated in FIG. 3A, the output of the TG 302 may be amplified, buffered, or attenuated by a variable gain amplifier (VGA) 303 before being input to the FBRX path 304. In the FBRX path 304, the tone (labeled “RF_TG”) may be amplified, buffered, or attenuated by a low noise amplifier (LNA) 306, the output of the LNA 306 is mixed with the LO for the TX path (labeled “LO_TX”) at a mixer 308 to generate frequency-converted signals in the baseband, and the frequency-converted signals are filtered by a baseband filter (BBF) 310 (e.g., a low-pass filter). The FBRX path 304 may also include an analog-to-digital converter (ADC) 312, although the ADC may not be internal to the transceiver integrated circuit (IC). For certain aspects, the output of the TG 302 (and the VGA 303) may be input to the mixer 308 directly, rather than input to the LNA 306.

During the FBRX RSB calibration, tones at the signal frequency (RF_TG−LO_TX, where LO_TX is the LO for the TX path) and at the image frequency (LO_TX−RF_TG) are available at the I and Q outputs of the FBRX ADC 312. The power difference (labeled “RSB_FBRX”) between the two tones represents the FBRX RSB or, equivalently, the FBRX phase and gain imbalance. By using the captured FBRX ADC outputs, phase and gain mismatches may be calculated in the modem and compensated after the ADC outputs in an effort to reduce the FBRX RSB.

The results of the FBRX RSB calibration may be stored in nonvolatile memory (e.g., memory 282) and recalled or otherwise used during the remainder of the TX RSB calibration, during other calibrations using the FBRX path, and during normal operation of the user terminal 120. For certain aspects, the FBRX RSB calibration may be performed at different operating parameters (e.g., at different temperatures and/or at different frequencies). In this case, the results of the FBRX RSB calibration may be stored with respect to these different operating parameters and may be recalled or otherwise used accordingly.

FIG. 3B is an example block diagram of the transceiver circuit of FIG. 3A in a second configuration 350 for calibrating the TX RSB after calibrating the FBRX RSB, in accordance with certain aspects of the present disclosure. In this second configuration 350, the output of the TX frequency synthesizing circuit 352 (labeled “TX Synth”) is configured as the LO for both the TX path 354 and the FBRX path 304. For certain aspects as illustrated in FIG. 3B, the output of the TX frequency synthesizing circuit 352 may be amplified by an amplifier 355 and/or frequency divided by a frequency dividing circuit 356 before being sent via switches 358, 360 (shown in the closed position) to the mixers 308, 362. Receiving input from a DAC 364, the TX path 354 may comprise a BBF 366, the mixer 362 for mixing the filtered signals from the BBF 336 with LO for the TX path (labeled “LO_TX”) to generate a frequency-converted RF signal, and a driver amplifier (DA) 368 for amplifying the RF signal. For certain aspects, the TX path 354 may also include a power amplifier (PA) 370 for amplifying the amplified RF signal from the DA 368, although the PA 370 may not be internal to the transceiver IC. Although the DAC 364 may also be considered as part of the TX path 354, the DAC may be external to the transceiver IC. The output of the TX path 354 (labeled “RF_TX”) is coupled to the input of the FBRX path 304 (e.g., via a duplexer 372 or a switch, an RF coupler 374, a programmable attenuator 376, and a switch 378 (shown in the closed position)).

During the TX RSB calibration, tones at the signal frequency (RF_TX−LO_TX) and the image frequency (IM=LO_TX−RF_TX) are available at the FBRX ADC outputs. The power difference (labeled “RSB_TX”) between the two tones represents the TX RSB or, equivalently, the TX phase and gain imbalance. By using the FBRX ADC outputs captured after calibrating the FBRX RSB, phase and gain mismatches of the TX path may be calculated in the modem and compensated before the I and Q inputs to the DAC 364 in an effort to reduce the TX RSB.

The results of the TX RSB calibration may be stored in nonvolatile memory (e.g., memory 282) and recalled or otherwise used during normal operation of the user terminal 120. For certain aspects, the TX RSB calibration may be performed at different operating parameters (e.g., at different temperatures, at different frequencies, and/or at different TX output power levels). In this case, the results of the TX RSB calibration may be stored with respect to these different operating parameters and may be recalled or otherwise used accordingly.

As an alternative to the first configuration 300 of FIG. 3A, FIG. 3C is an example block diagram of the transceiver circuit of FIG. 3A in a third configuration 380 for calibrating the FBRX RSB, in accordance with certain aspects of the present disclosure. In the third configuration 380, the output of the TX path 354 (which may be a tone labeled “RF_TX”) is coupled to the input of the FBRX path 304 (e.g., via the duplexer 372 or a switch, the RF coupler 374, the programmable attenuator 376, and the switch 378), rather than the output of the TG 302. In the FBRX path 304, the output of the TX path 354 (or the attenuated output of the programmable attenuator 376, if used) may be amplified by the LNA 306, the amplified output of the LNA 306 may be mixed with the output of the TG 302 (labeled “LO_TG”) provided via a switch 384 (shown in the closed position) at the mixer 308 to generate frequency-converted signals in the baseband, and the frequency-converted signals may be filtered by the BBF 310. For certain aspects as illustrated in FIG. 3C, the output of the TG 302 may be amplified by an amplifier 382 before being input to the mixer 308. For certain aspects, the output of the TX path 354 (or the attenuated output of the programmable attenuator 376) may be input to the mixer 308 directly, rather than input to the LNA 306.

During the FBRX RSB calibration using the third configuration 380, tones at the signal frequency (RF_TX−LO_TG) and at the image frequency (LO_TG−RF_TX) are available at the I and Q outputs of the FBRX ADC 312. The power difference (labeled “RSB_FBRX”) between the two tones represents the FBRX RSB or, equivalently, the FBRX phase and gain imbalance. By using the captured FBRX ADC outputs, phase and gain mismatches may be calculated in the modem and compensated after the ADC outputs in an effort to reduce the FBRX RSB.

FIG. 3D is an example block diagram of the transceiver circuit of FIG. 3A configured to in a fourth configuration 390 for calibrating the TX RSB after calibrating the FBRX RSB according to the third configuration 380 in FIG. 3C, in accordance with certain aspects of the present disclosure. The fourth configuration 390 is similar to the second configuration 350 of FIG. 3B, except that the TG 302 (labeled “LO_TG”) functions as the LO for the FBRX path 304, rather than the output of the TX frequency synthesizing circuit 352. To accomplish this, the switch 360 is open, and the switch 384 is closed. For certain aspects as illustrated in FIG. 3D, the output of the TG 302 may be amplified by an amplifier 382 before being input to the mixer 308. For certain aspects, the output of the TX path 354 (or the attenuated output of the programmable attenuator 376) may be input to the mixer 308 directly, rather than input to the LNA 306.

During the TX RSB calibration, tones at the signal frequency (RF_TX−LO_TG) and the image frequency (IM=LO_TG−RF_TX) are available at the FBRX ADC outputs. The power difference (labeled “RSB_TX”) between the two tones represents the TX RSB or, equivalently, the TX phase and gain imbalance. By using the FBRX ADC outputs captured after calibrating the FBRX RSB, phase and gain mismatches of the TX path may be calculated in the modem and compensated before the I and Q inputs to the DAC 364 in an effort to reduce the TX RSB.

### Example TX LO Leakage Calibration

LO leakage calibration, correction, or adjustment may also be referred to as carrier suppression. For ease of description and to avoid confusion, the present disclosure hereinafter uses LO leakage calibration.

To calibrate the TX LO leakage, if the TX frequency synthesizing circuit 352 is used as the LO for both the TX and FBRX paths 354, 304, the LO leakage falls at DC. Consequently, the DC offset of the FBRX path 304 upsets the LO leakage measurement.

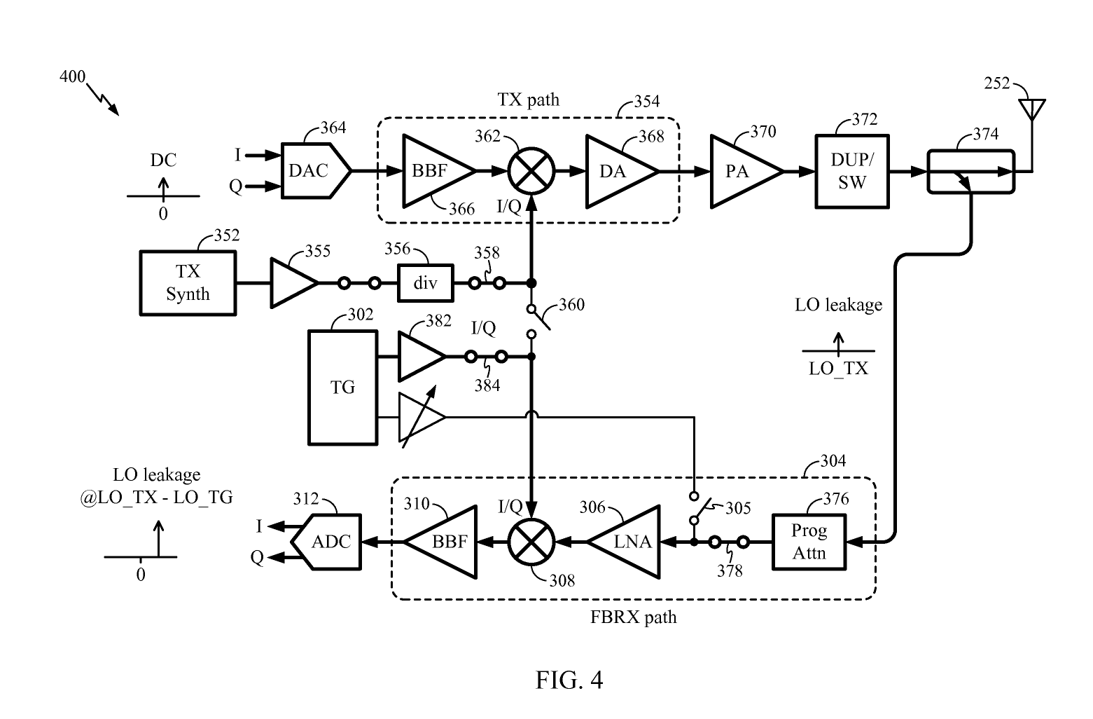

To solve this problem when calibrating the TX LO leakage, a third configuration 400 of FIG. 3A's transceiver circuit is used, as illustrated in FIG. 4. In this third configuration 400, the TG 302 is configured as the LO to the FBRX at a frequency different from the TX LO, and the output of the TG 302 may be amplified by the amplifier 382 and input to the mixer 308 via the switch 384 (shown in the closed position). Switches 305 and 360 are open in the third configuration 400. The TX frequency synthesizing circuit 352 is configured as the LO for the TX path 354. The output of the TX path 354 is coupled to the input of the FBRX path 304 (e.g., via the duplexer 372 or a switch, the RF coupler 374, the programmable attenuator 376, and the switch 378), as described above. During the LO leakage calibration, a tone at LO_TX−LO_TG is available at the FBRX ADC outputs. The power of this tone represents the amount of LO leaked at the output of the TX path 354. By capturing the FBRX ADC outputs in this configuration, the LO leakage may be optimized.

For certain aspects, the magnitude of the captured data is measured by using the sum of the square of the in-phase and the square of the quadrature signals (i.e., I²+Q²). This is equivalent to calculating the power of the FBRX ADC outputs at LO_TX−LO_TG by using a fast Fourier transform (FFT). Any of various suitable search algorithms (e.g., a binary search) may be performed to find the minimum magnitude (e.g., I²+Q²) by adjusting the DC offsets of the TX DAC inputs.

The results of the LO leakage calibration (e.g., the DC offsets of the TX DAC inputs) may be stored in nonvolatile memory (e.g., memory 282) and recalled during normal operation of the user terminal 120. For certain aspects, the LO leakage calibration may be performed at different operating parameters (e.g., at different temperatures, at different frequencies, and/or with different TX output power levels). In this case, the results of the LO leakage calibration may be stored with respect to these different operating parameters and may be recalled or otherwise used accordingly.

For TX RSB and LO leakage calibration, the output of either the DA 368 or the PA 370 may be coupled back to the FBRX input. In a system with multiple DA and PA paths connected with a single antenna via multiple duplexers or RF switches, the TX output may be coupled back to the FBRX input via a single coupler (e.g., RF coupler 374) in front of the antenna to simplify the coupling path. For certain aspects, the switches 305, 358, 360, 384 in the TG (LO and RF outputs) and LO paths, as shown in FIGS. 3A, 3B, and 4, may be substituted by tri-state buffers.

### Example Implementation of the Reconfigurable TG

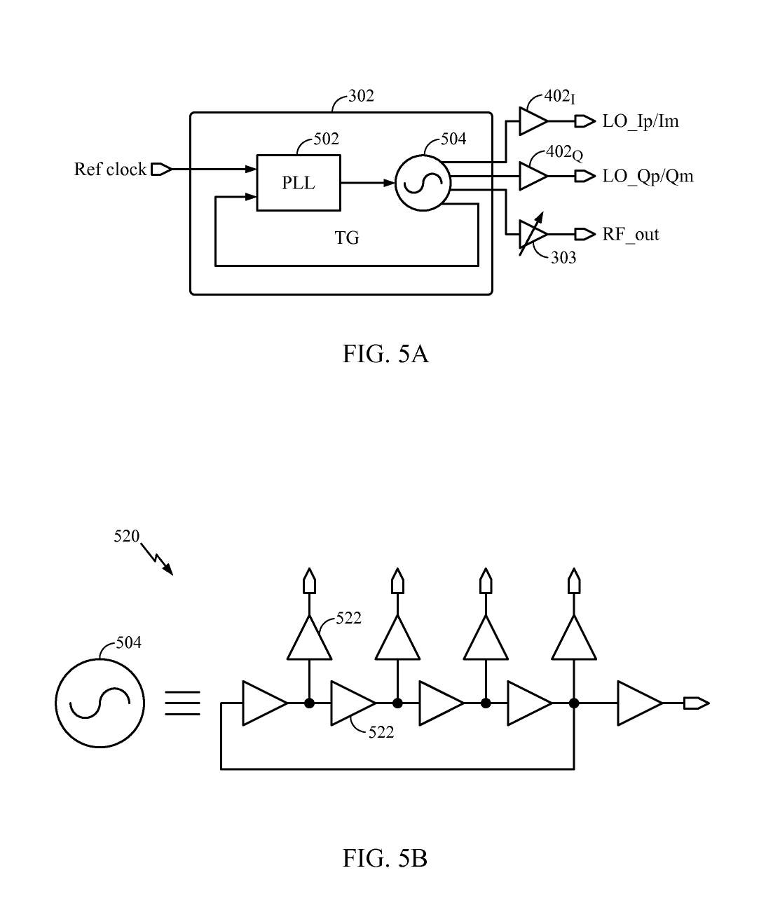

According to certain aspects, the TG 302 may be implemented as a phase-locked loop (PLL) 502 with a VCO 504, as illustrated in FIG. 5A. Other functionally equivalent circuits are possible for the TG 302. For certain aspects, the VCO 504 for the TG may be a multi-stage VCO. FIG. 5B is an example block diagram of a four-stage VCO 520 for the TG 302 of FIG. 5A, in accordance with certain aspects of the present disclosure. This four-stage oscillator may provide quadrature LOs to the TX and/or FBRX paths via various buffers and/or amplifiers 522, as shown in FIG. 5A. By turning on and off the LO buffers, amplifiers, and programmable attenuator, the TG 302 may be configured to either provide LO signals or an adjustable RF signal to the FBRX path 304, for example. For other aspects, the VCO 504 in the TG may be implemented as an oscillator followed by a quadrature phase-splitter or other functionally equivalent circuitry.

### Advantages

Certain aspects of the present disclosure provide calibration techniques such that the TX RSB and LO leakage constraints may be complied with over process corners, including the more restrictive specifications of an ET/EPT system. This helps enable the use of a low-cost PA in a transmitter with competitive ACLR while maintaining good power efficiency. These calibration techniques involve part-to-part calibration (e.g., individual user terminal calibration), which typically results in better performance when compared to statistically derived compensation for all user terminals 120.

Moreover, by down-converting the LO leakage to a non-DC baseband tone in the FBRX, measuring or separating the DC offset of the FBRX need not be performed. This simplifies the process of estimating the LO leakage power at the FBRX output.

Finally, by including the TX DAC 364 when measuring the phase and gain mismatches as well as the LO leakage, the compensation accounts for the non-idealities in the full TX chain. This improves the performance after the calibration, especially in cases where the TX DAC 364 and the remainder of the TX path 354 are partitioned into two separate ICs.

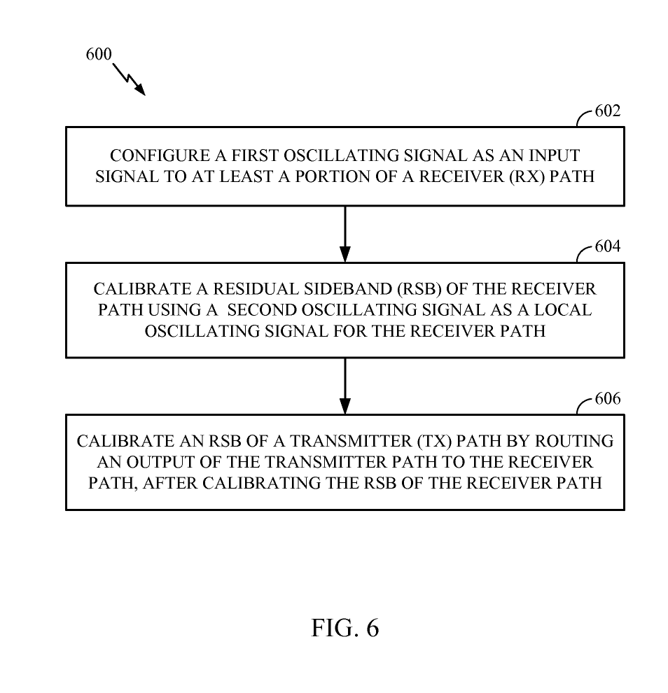

FIG. 6 is a flow diagram of example operations 600 for calibrating the RSB of a transmitter path, in accordance with certain aspects of the present disclosure. The operations 600 may begin, at 602, by configuring a first oscillating signal as an input signal to at least a portion of a receiver (RX) path. The receiver path may be a feedback receiver (FBRX) path, for example, which may be internal to the transceiver. For other aspects, the FBRX path may be external to the transceiver (e.g., on another IC different from the transceiver IC). For certain aspects, the at least the portion of the receiver path includes a low noise amplifier (LNA), a mixer, and a (baseband) filter. For certain aspects, the at least the portion of the receiver path includes a mixer and a (baseband) filter, without the LNA being included in the at least the portion (even if present in the receiver path). For certain aspects, the receiver path may also include an analog-to-digital converter (ADC), although the ADC may not be internal to the transceiver integrated circuit (IC).

At 604, a residual sideband (RSB) of the receiver path may be calibrated using a second oscillating signal as a local oscillating signal for the receiver path. According to certain aspects, calibrating the RSB of the receiver path at 604 involves amplifying the first oscillating signal with a low noise amplifier (LNA) and mixing the amplified signal with the local oscillating signal for the receiver path to produce a baseband frequency at a difference between frequencies of the amplified signal and the local oscillating signal (e.g., RF_TG−LO_TX). For other aspects, calibrating the RSB of the receiver path involves mixing the first oscillating signal with the local oscillating signal for the receiver path to produce a baseband frequency at a difference between frequencies of the first oscillating signal and the local oscillating signal.

At 606, an RSB of the transmitter path may be calibrated by routing an output of the transmitter path to the receiver path, after calibrating the RSB of the receiver path. For certain aspects, the second oscillating signal may be used as the local oscillating signal for the receiver path during the TX RSB calibration at 606. For certain aspects, the routing at 606 entails routing the output of the transmitter path to the receiver path via at least one of a power amplifier (PA), a duplexer, a radio frequency (RF) switch, or a coupler. In other cases, the routing at 606 involves routing the output of the transmitter path to the receiver path via a coupler in front of an antenna (i.e., between the antenna and the transmitter path) and at least one of multiple power amplifiers, multiple duplexers, or multiple RF switches. For certain aspects, the transmitter path may include a (baseband) filter, a mixer, and a driver amplifier (DA). For certain aspects, the transmitter path may also include a digital-to-analog converter (DAC), although the DAC may not be internal to the transceiver IC.

According to certain aspects, calibrating the RSB of the transmitter path at 606 involves receiving an input to the transmitter path from a DAC, filtering the input to the transmitter path to produce a filtered signal, and mixing the filtered signal with a third oscillating signal as a local oscillating signal for the transmitter path to produce the output of the transmitter path at a radio frequency (e.g., the sum of the local oscillating signal's frequency and the filtered signal's frequency). The third oscillating signal may be the same as the second oscillating signal. For other aspects, the second and third oscillating signals may be different. For certain aspects, calibrating the RSB of the transmitter path at 606 entails attenuating the output of the transmitter path to produce an attenuated signal, amplifying the attenuated signal with an LNA, and mixing the amplified signal with the local oscillating signal for the receiver path to produce a baseband frequency at a difference between frequencies of the amplified signal and the local oscillating signal. For other aspects, calibrating the RSB of the transmitter path at 606 involves amplifying the output of the transmitter path (e.g., without attenuation) with an LNA and mixing the amplified output with the local oscillating signal for the receiver path to produce a baseband frequency at a difference between frequencies of the amplified output and the local oscillating signal. For certain aspects, calibrating the RSB of the transmitter path involves calculating phase and gain mismatches for compensating inputs to a DAC associated with the transmitter path.

According to certain aspects, the operations 600 may further include disconnecting the first oscillating signal from the at least the portion of the receiver path before calibrating the RSB of the transmitter path. In this case, the third oscillating signal may be the second oscillating signal (i.e., the second and third oscillating signals are the same signal).

According to certain aspects, calibrating the RSB of the receiver path at 604 and calibrating the RSB of the transmitter path at 606 are both performed in the time domain (as opposed to the frequency domain).

According to certain aspects, the operations 600 may further include adjusting a gain of a variable gain amplifier (VGA) for amplifying, buffering, or attenuating the first oscillating signal, such that the amplified, buffered, or attenuated signal is used as the input signal to the least the portion of the receiver path.

According to certain aspects, the second oscillating signal is produced by a VCO associated with the transmitter path during normal transceiver operations.

According to certain aspects, the first oscillating signal is produced by a tone generating circuit, which may be associated with calibration operations of the transceiver. The tone generating circuit may be internal to the transceiver. For other aspects, the tone generating circuit may be external to the transceiver (e.g., on a different IC than the transceiver). For certain aspects, the tone generating circuit includes a multi-stage voltage-controlled oscillator (VCO). In this case, the second oscillating signal may be produced by a VCO associated with the transmitter path during normal transceiver operations. For certain aspects, the tone generating circuit may be a single tone generating circuit.

According to certain aspects, the first oscillating signal is produced by the transmitter path and routed to the at least the portion of the receiver path. In this case, the second oscillating signal may be produced by a tone generating circuit, which may be associated with calibration operations of the transceiver. The tone generating circuit may be internal or external to the transceiver.

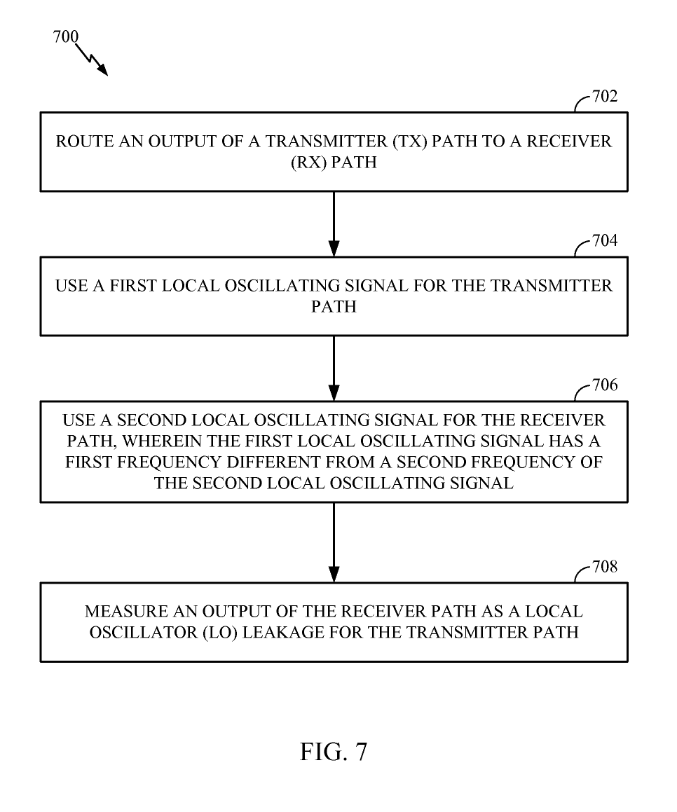

FIG. 7 is a flow diagram of example operations 700 for calibrating the LO leakage of a transmitter path, in accordance with certain aspects of the present disclosure. The operations 700 may begin, at 702, by routing an output of a transmitter path to a receiver (RX) path. The receiver path may be a feedback receiver (FBRX) path, for example, which may be internal to the transceiver. For certain aspects, the routing involves routing the output of the transmitter path to the receiver path via at least one of a power amplifier (PA), a duplexer, an RF switch, or a coupler. For other aspects, the routing at 702 entails routing the output of the transmitter path to the receiver path via a coupler in front of an antenna (i.e., between the antenna and the transmitter path) and at least one of multiple power amplifiers, multiple duplexers, or multiple RF switches.

At 704, a first local oscillating signal may be used for the transmitter path, and at 706, a second local oscillating signal may be used for the receiver path. The first local oscillating signal has a first frequency different from a second frequency of the second local oscillating signal. For certain aspects, the first local oscillating signal is produced by a voltage-controlled oscillator (VCO) associated with the transmitter path during normal transceiver operations. For certain aspects, the second local oscillating signal is produced by a tone generating circuit associated with calibration operations of the transceiver. The tone generating circuit may be internal (or external) to the transceiver. For certain aspects, the tone generating circuit may be a single tone generating circuit.

At 708, an output of the receiver path is measured as a local oscillator (LO) leakage for the transmitter path. For certain aspects, measuring the LO leakage occurs in the time domain (as opposed to the frequency domain). According to certain aspects, the operations 700 may further include calibrating the LO leakage of the transmitter path by using the LO leakage measured at the output of the receiver path to compensate inputs to a DAC associated with the transmitter path.

According to certain aspects, the operations 700 further include adjusting a direct current (DC) offset of an input to the transmitter path to yield different LO leakages at the output of the receiver path; measuring magnitudes of the different LO leakages; and selecting the adjusted DC offset yielding a minimum LO leakage magnitude for the transceiver. For certain aspects, the input to the transmitter path includes an input to a DAC associated with the transmitter path. For certain aspects, the adjusting may involve performing a binary search (or any other suitable search algorithm) based on measuring the magnitudes of the different LO leakages. For certain aspects, measuring the magnitudes of the different LO leakages entails measuring a magnitude of an in-phase (I) signal output from the receiver path; measuring a magnitude of a quadrature (Q) signal output from the receiver path; and calculating a sum of a square of the magnitude of the I signal and a square of the magnitude of the Q signal. For certain aspects, measuring the magnitudes of the different LO leakages involves measuring a magnitude of the output of the receiver path at a difference between the first and second frequencies. The difference between the first and second frequencies may be a non-DC baseband tone. For certain aspects, the operations 700 further include operating the transceiver using the selected DC offset.

According to certain aspects, the operations 700 may further include inputting a DC signal to a DAC associated with the transmitter path, at least before measuring the output of the receiver path.

According to certain aspects, the operations 700 may further include receiving an input to the transmitter path from a DAC, filtering the input to the transmitter path to produce a filtered signal, and mixing the filtered signal with the first local oscillating signal to produce the output of the transmitter path at a baseband frequency.

The various operations or methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for transmitting may comprise a transmitter (e.g., the transceiver front end 254 of the user terminal 120 depicted in FIG. 2 or the transceiver front end 222 of the access point 110 shown in FIG. 2) and/or an antenna (e.g., the antennas 252ma through 252mu of the user terminal 120m portrayed in FIG. 2 or the antennas 224a through 224ap of the access point 110 illustrated in FIG. 2). Means for receiving may comprise a receiver (e.g., the transceiver front end 254 of the user terminal 120 depicted in FIG. 2 or the transceiver front end 222 of the access point 110 shown in FIG. 2) and/or an antenna (e.g., the antennas 252ma through 252mu of the user terminal 120m portrayed in FIG. 2 or the antennas 224a through 224ap of the access point 110 illustrated in FIG. 2). Means for processing or means for determining may comprise a processing system, which may include one or more processors, such as the RX data processor 270, the TX data processor 288, and/or the controller 280 of the user terminal 120 illustrated in FIG. 2.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for calibrating a transceiver for wireless communications, comprising:
configuring a first oscillating signal as an input signal to at least a portion of a receiver path;
calibrating a residual sideband (RSB) of the receiver path using a second oscillating signal as a local oscillating signal for the receiver path; and
calibrating an RSB of a transmitter path by routing an output of the transmitter path to the receiver path, after calibrating the RSB of the receiver path.

2. The method of claim 1, wherein calibrating the RSB of the receiver path comprises:
amplifying the first oscillating signal with a low noise amplifier (LNA); and
mixing the amplified signal with the local oscillating signal for the receiver path to produce a baseband frequency at a difference between frequencies of the amplified signal and the local oscillating signal.

3. The method of claim 1, wherein calibrating the RSB of the receiver path comprises mixing the first oscillating signal with the local oscillating signal for the receiver path to produce a baseband frequency at a difference between frequencies of the first oscillating signal and the local oscillating signal.

4. The method of claim 1, further comprising disconnecting the first oscillating signal from the at least the portion of the receiver path before calibrating the RSB of the transmitter path.

5. The method of claim 1, wherein calibrating the RSB of the transmitter path comprises:
attenuating the output of the transmitter path to produce an attenuated signal;
amplifying the attenuated signal with a low noise amplifier (LNA); and
mixing the amplified signal with the local oscillating signal for the receiver path to produce a baseband frequency at a difference between frequencies of the amplified signal and the local oscillating signal.

6. The method of claim 1, wherein calibrating the RSB of the transmitter path comprises:
receiving an input to the transmitter path from a digital-to-analog converter (DAC);
filtering the input to the transmitter path to produce a filtered signal; and
mixing the filtered signal with a third oscillating signal as a local oscillating signal for the transmitter path to produce the output of the transmitter path at a radio frequency.

7. The method of claim 6, wherein the third oscillating signal is the second oscillating signal.

8. The method of claim 1, wherein calibrating the RSB of the receiver path and calibrating the RSB of the transmitter path are performed in the time domain.

9. The method of claim 1, wherein calibrating the RSB of the transmitter path comprises calculating phase and gain mismatches for compensating inputs to a digital-to-analog converter (DAC) associated with the transmitter path.

10. The method of claim 1, further comprising adjusting a gain of a variable gain amplifier (VGA) for amplifying, buffering, or attenuating the first oscillating signal, such that the amplified, buffered, or attenuated signal is used as the input signal to the least the portion of the receiver path.

11. The method of claim 1, wherein the first oscillating signal is produced by a tone generating circuit and wherein the second oscillating signal is produced by a voltage-controlled oscillator (VCO) associated with the transmitter path during normal transceiver operations.

12. The method of claim 1, wherein the first oscillating signal is produced by the transmitter path and routed to the at least the portion of the receiver path and wherein the second oscillating signal is produced by a tone generating circuit.

13. The method of claim 1, wherein the routing comprises routing the output of the transmitter path to the receiver path via at least one of a power amplifier (PA), a duplexer, a radio frequency (RF) switch, or a coupler.

14. An apparatus for wireless communications, comprising:
a transmitter path;
a receiver path; and
a processing system configured to:
configure a first oscillating signal as an input signal to at least a portion of the receiver path;
calibrate a residual sideband (RSB) of the receiver path using a second oscillating signal as a local oscillating signal for the receiver path; and
calibrate an RSB of a transmitter path by routing an output of the transmitter path to the receiver path, after calibrating the RSB of the receiver path.

15. The apparatus of claim 14, wherein the at least the portion of the receiver path comprises a low noise amplifier (LNA), a mixer, and a filter.

16. The apparatus of claim 14, wherein the first oscillating signal is produced by a tone generating circuit associated with calibration operations of at least one of the transmitter path or the receiver path.

17. The apparatus of claim 16, wherein the tone generating circuit is internal to an integrated circuit having at least one of the transmitter path or the receiver path and wherein the tone generating circuit comprises a multi-stage voltage-controlled oscillator (VCO).

18. The apparatus of claim 14, wherein the first oscillating signal is produced by the transmitter path and routed to the at least the portion of the receiver path.

19. A method for calibrating a transceiver for wireless communications, comprising:
routing an output of a transmitter path to a receiver path;
using a first local oscillating signal for the transmitter path;
using a second local oscillating signal for the receiver path, wherein the first local oscillating signal has a first frequency different from a second frequency of the second local oscillating signal; and
measuring an output of the receiver path as a local oscillator (LO) leakage for the transmitter path.

20. The method of claim 19, further comprising:
adjusting a direct current (DC) offset of an input to the transmitter path to yield different LO leakages at the output of the receiver path;
measuring magnitudes of the different LO leakages; and
selecting the adjusted DC offset yielding a minimum LO leakage magnitude for the transceiver.

21. The method of claim 20, wherein the adjusting comprises performing a binary search based on measuring the magnitudes of the different LO leakages.

22. The method of claim 20, wherein measuring the magnitudes of the different LO leakages comprises:
measuring a magnitude of an in-phase (I) signal output from the receiver path;
measuring a magnitude of a quadrature (Q) signal output from the receiver path; and
calculating a sum of a square of the magnitude of the I signal and a square of the magnitude of the Q signal.

23. The method of claim 20, wherein measuring the magnitudes of the different LO leakages comprises measuring a magnitude of the output of the receiver path at a difference between the first and second frequencies and wherein the difference between the first and second frequencies is a non-DC baseband tone.

24. The method of claim 20, further comprising operating the transceiver using the selected DC offset.

25. The method of claim 19, wherein measuring the LO leakage occurs in the time domain.

26. The method of claim 19, wherein the routing comprises routing the output of the transmitter path to the receiver path via at least one of a power amplifier (PA), a duplexer, a radio frequency (RF) switch, or a coupler.

27. The method of claim 19, wherein the first local oscillating signal is produced by a voltage-controlled oscillator (VCO) associated with the transmitter path during normal transceiver operations and wherein the second local oscillating signal is produced by a tone generating circuit associated with calibration operations of the transceiver.

28. The method of claim 19, wherein the receiver path comprises a feedback receiver (FBRX) path internal to the transceiver.

29. The method of claim 19, further comprising calibrating the LO leakage of the transmitter path by using the LO leakage measured at the output of the receiver path to compensate inputs to a digital-to-analog converter (DAC) associated with the transmitter path.

30. An apparatus for wireless communications, comprising:
a transmitter path;
a receiver path; and
a processing system configured to:
route an output of the transmitter path to the receiver path;
use a first local oscillating signal for the transmitter path;
use a second local oscillating signal for the receiver path, wherein the first local oscillating signal has a first frequency different from a second frequency of the second local oscillating signal; and
measure an output of the receiver path as a local oscillator (LO) leakage for the transmitter path.
